(19) United States
(12) Patent Application Publication
(10) Pub. No.: US 2015/0285481 A1
(43) Pub. Date: Oct. 8, 2015

(54) LIGHT ASSEMBLY HAVING REFLECTIVE STRUCTURE

(71) Applicant: Jen Shieh SHIH, Changhua (TW)

(72) Inventor: Jen Shieh SHIH, Changhua (TW)

(73) Assignee: Jen Shieh Shih, Changhua (TW)

(21) Appl. No.: 14/243,013

(22) Filed: Apr. 2, 2014

(51) Int. Cl. F21V 29/503; F21V 19/00; F21V 15/01; F21V 23/00; F21K 99/00; F21V 7/00

(52) U.S. Cl. CPC F21V 29/503; F21K 9/50; F21V 7/0066; F21V 15/01; F21V 23/001; F21V 19/003; F21Y 2101/02

(57) ABSTRACT

A light assembly includes a housing, a light element disposed on the housing, a reflective member to be supported and spaced from the light element, and the reflective member includes a reflective surface faced toward the light element for reflecting a light generated by the light element, and a frame is engaged between the reflective member and the light element for supporting and separating the reflective member from the light element for a distance, and for allowing the light generated by the light element to be reflected by the reflective surface of the reflective member, and for allowing a heat generated by the light element to be dissipated through the space between the reflective member and the light element.

### BACKGROUND OF THE INVENTION

1. Field of the Invention

The present invention relates to a light emitting diode (LED) light assembly, and more particularly to an LED light assembly including a structure for allowing the light assembly to be easily and quickly assembled and including a reflective structure for suitably reflecting the light generated by the light assembly and for allowing the heat generated by the light element to be suitably dissipated through the space between a reflective member and the light element.

2. Description of the Prior Art

Typical light devices or light assemblies or light facilities comprise a battery disposed in a receptacle and coupled to a light bulb, such as a light emitting diode (LED) light bulb for energizing the light bulb, and for actuating the light bulb to generate the indicating light or the flash light or the light.

For example, U.S. Pat. No. 4,368,507 to Reynolds, U.S. Pat. No. 5,154,600 to Sylvestre, and U.S. Pat. No. 5,483,956 to Shapiro disclose three of the typical flashlights, illumination kits, or night lights, and each comprising a supporting case or body for receiving or accommodating one or more light bulbs, and a battery coupled to the light bulbs for energizing the light bulbs to generate various lights or flashlights.

However, the typical flashlights, illumination kits, or night lights may not be easily used or operated by the users, and may not be used or operated selectively for the hand-held flashlights and the lights respectively, particularly when the electric power source is cut off or has become failure.

The present invention has arisen to mitigate and/or obviate the afore-described disadvantages of the conventional light devices or facilities.

### SUMMARY OF THE INVENTION

The primary objective of the present invention is to provide a light assembly including a structure for allowing the light assembly to be easily and quickly assembled.

The other objective of the present invention is to provide a light assembly including a reflective structure for suitably reflecting the light generated by the light assembly and for allowing the heat generated by the light element to be suitably dissipated through the space between a reflective member and the light element.

In accordance with one aspect of the invention, there is provided a light assembly comprising a housing including a platform, a light element disposed on the platform of the housing and secured to the housing, a reflective member supported and spaced from the light element, and the reflective member including a reflective surface provided therein and faced toward the light element for reflecting a light generated by the light element, and a frame engaged or secured between the reflective member and the light element for supporting and separating the reflective member from the light element for a selected space or distance, and for allowing the light generated by the light element to be suitably reflected by the reflective surface of the reflective member, and for allowing the heat generated by the light element to be dissipated through the space between the reflective member and the light element.

The housing includes a chamber formed therein, a circuit board is disposed on the platform of the housing for supporting the light element, and two wires are coupled to the circuit board and engaged through the platform of the housing and engaged in the chamber of the housing.

A cover or shield may further be provided and attached to the housing and engaged onto the circuit board for anchoring the circuit board to the housing and/or for covering or shielding the circuit board, the cover includes an opening formed therein for receiving and engaging with the light element and for allowing the light element to be exposed, and for allowing the light generated by the light element to be emitted out of the cover.

The housing includes a peripheral flange extended laterally and outwardly therefrom, and a gasket is attached onto the housing and engaged with the peripheral flange of the housing for solidly and stably anchoring or retaining the gasket to the housing and for protecting the housing. The reflective surface of the reflective member is preferably selected from a tilted or inclined or cone-shaped reflective surface.

The housing includes at least one blind hole formed therein, and the frame includes a head engaged with the reflective member, and at least one rod extended from the head of the frame and engaged into the blind hole of the housing for supporting and separating the reflective member from the light element for the selected space or distance.

The head of the frame includes a triangular shape. The reflective member includes a recess formed therein for engaging with the head of the frame. The reflective member includes at least one seat provided therein and having the recess formed in the seat for engaging with the head of the frame.

The reflective member includes a cap secured to the reflective member for shielding and covering the head of the frame. The cap includes a depression formed therein, and a lid received and engaged in the depression of the cap for shielding and covering a fastener which may be used to solidly secure the cap to the reflective member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a light assembly in accordance with the present invention;

FIG. 2 is a cross sectional view of the light assembly taken along lines 2-2 of FIG. 1;

FIG. 3 is a partial exploded view of the light assembly;

FIG. 4 is another perspective view of the light assembly, illustrating a reflective member of the light assembly;

FIG. 5 is another partial exploded view of the light assembly; and

FIG. 6 is a side plan schematic view illustrating the operation of the light assembly.

### DETAILED DESCRIPTION OF THE PREFERRED EMBODIMENT

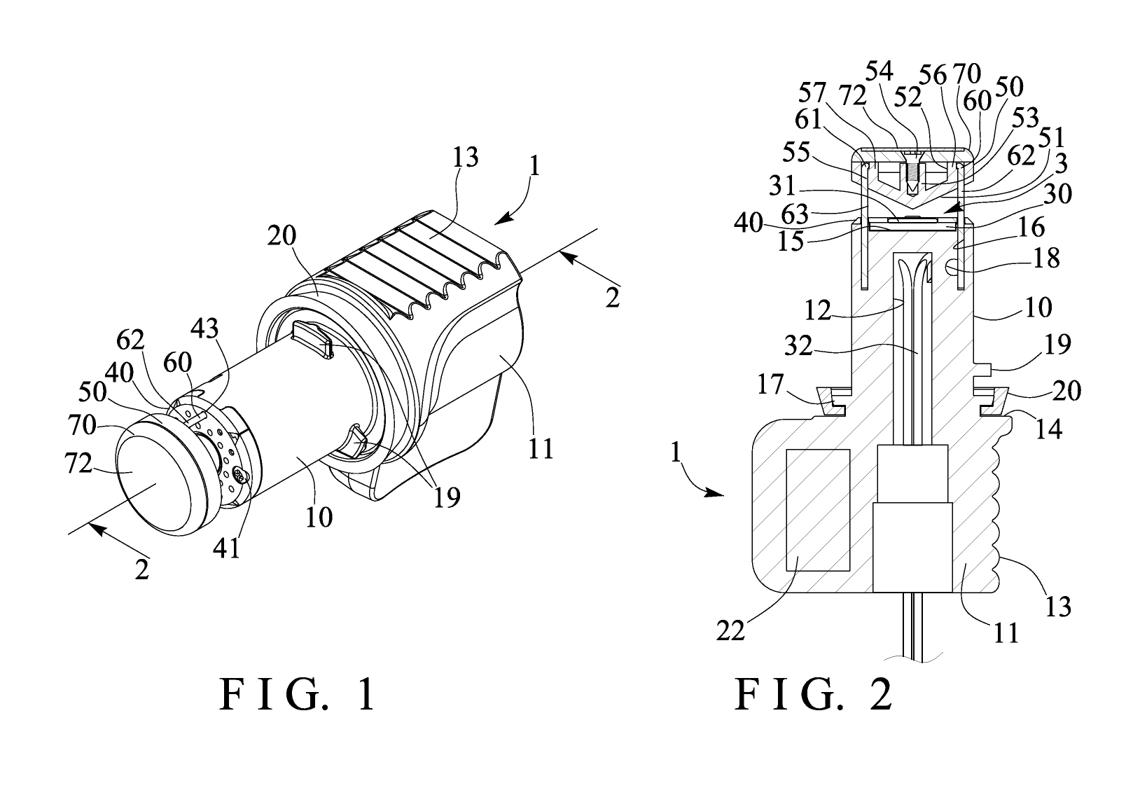

Referring to the drawings, and initially to FIGS. 1-3, a light assembly in accordance with the present invention comprises a receptacle 1 including a housing 10 having a handle 11 formed or provided on end portion thereof, and including a compartment or chamber 12 formed in the housing 10 (FIG. 2), and including a wavy structure having one or more bulges or fins 13 formed or provided in the handle 11 for heat dissipating purposes, the handle 11 includes an outer diameter greater than that of the housing 10 for forming or defining a peripheral shoulder 14 between the housing 10 and the handle 11 (FIGS. 2-3, 6), and the housing 10 includes a recess or depression or platform 15 formed or provided in the free end portion of the housing 10, and includes one or more (such as two) blind holes 16 formed in the free end portion of the housing 10 and arranged or located beside the platform 15 and communicating with the chamber 12 of the housing 10 (FIG. 2).

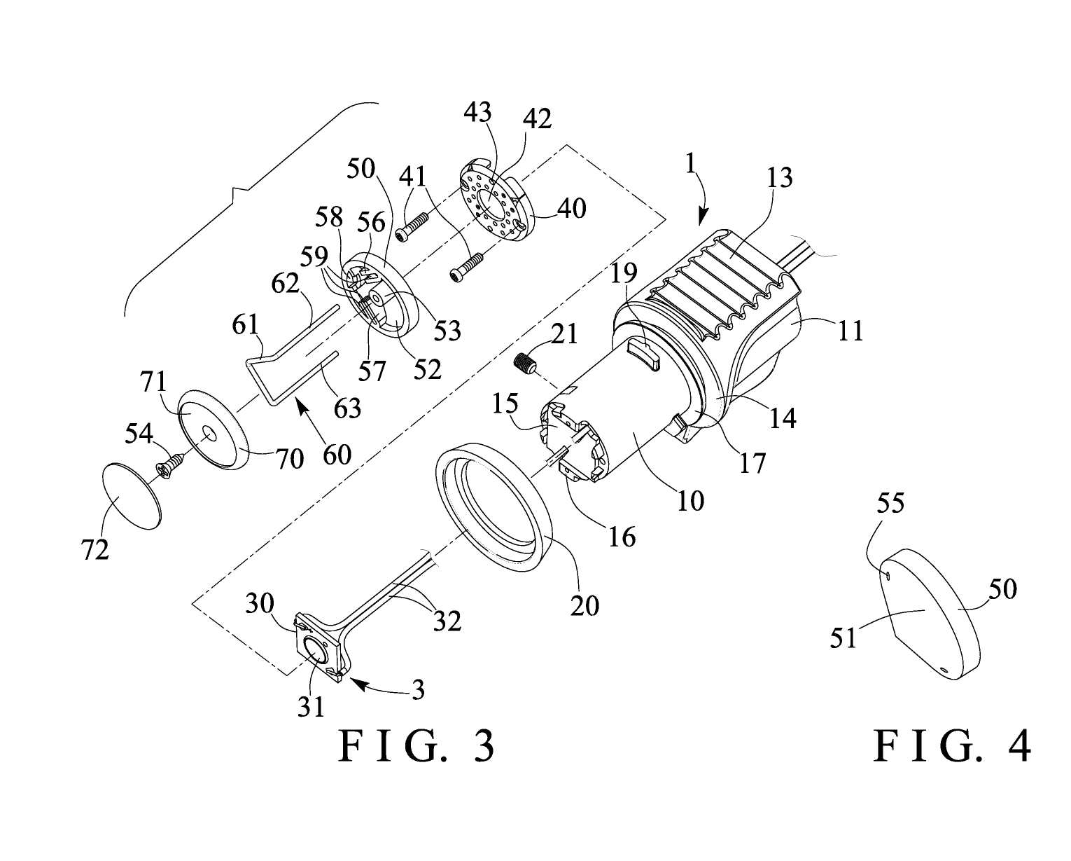

The housing 10 includes a peripheral flange 17 extended laterally and outwardly from one end portion thereof and located close to the handle 11 (FIGS. 2-3) and arranged or located close to the peripheral shoulder 14 that is formed and located between the housing 10 and the handle 11. A sealing ring or pad or gasket 20 is attached or mounted or engaged onto the housing 10 and engaged with the peripheral flange 17 for solidly and stably anchoring or retaining or securing to the housing 10. The housing 10 further includes one or more orifices 18 formed therein and communicating with the blind holes 16 of the housing 10 (FIG. 2) for receiving or engaging with latches or fasteners 21 respectively, and further includes one or more flaps or ears 19 extended laterally and outwardly from the housing 10 for anchoring or retaining or coupling to the other supporting cases or objects (not shown).

A light member or device 3 includes a processor device or circuit board 30 disposed or engaged into the recess or depression or platform 15 of the housing 10, one or more light bulbs or elements 31, such as light emitting diode (LED) light elements 31 disposed or attached or mounted or engaged onto the circuit board 30 for generating the indicating light or the flashlight or the like. The light device 3 further includes one or more (such as two) terminals or electrodes or wires 32 coupled to the circuit board 30 and/or the light element 31 and engaged through the platform 15 of the housing 10, and received or engaged in the chamber 12 of the housing 10 (FIG. 2) for coupling to a typical electrical socket (not shown) and for receiving the electric power or energy from the electrical socket (not shown); or, the housing 10 may include one or more batteries 22 received or engaged in the housing 10 (FIG. 2) and electrically coupled to the wires 32 for energizing the light element 31 to generate various lights or flashlights.

A shield or cover 40 is attached or mounted or engaged onto the free end portion of the housing 10 and engaged onto the circuit board 30 and the light element 31 and for shielding or covering and anchoring or retaining or securing the circuit board 30 to the housing 10, and solidly and stably secured to the housing 10 with one or more (such as two) fasteners 41, the cover 40 includes an opening 42 formed therein for receiving or engaging with the light element 31 and for allowing the light element 31 to be exposed, and for allowing the light generated by the light element 31 to be emitted out of the cover 40 and the housing 10, best shown in FIG. 6, and the cover 40 further includes one or more (such as two) apertures 43 formed therein and aligned with the blind holes 16 of the housing 10.

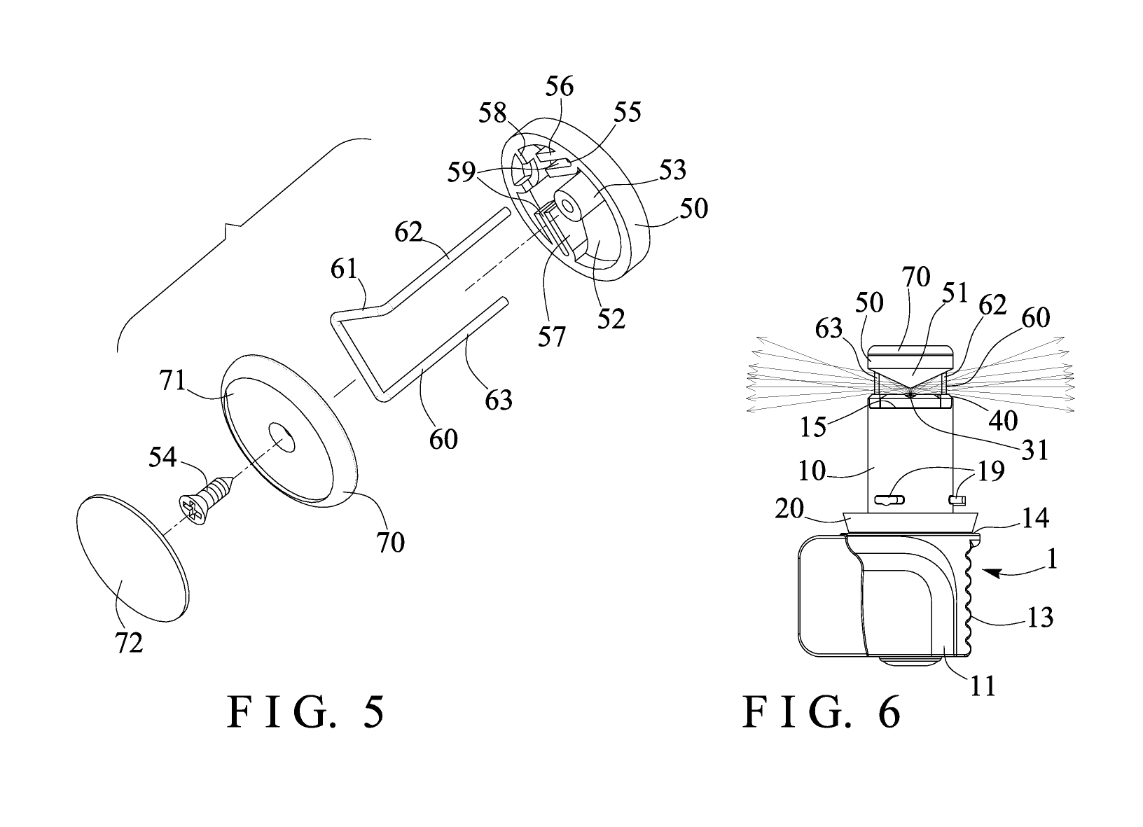

As shown in FIGS. 1-6, a reflective member 50 is to be attached or mounted or secured to the upper or free end portion of the housing 10 with a stay or supporting member or frame 60 or the like, and suitably spaced or separated from the circuit board 30 and/or the light element 31, and includes a tilted or inclined or cone-shaped reflective surface 51 formed or provided therein and faced or directed toward the light element 31 (FIGS. 2, 6) for suitably reflecting the light generated by the light element 31, and includes a recess or depression or space 52 formed therein and located opposite to the reflective surface 51 of the reflective member 50, and includes a stud 53 extended from the center portion of the reflective member 50 and extended into the space 52 of the reflective member 50 for engaging with a latch or fastener 54 (FIGS. 2, 3) or the like.

The reflective member 50 further includes one or more (such as two) cavities 55 formed therein (FIGS. 2, 4-5) and communicating with the space 52 of the reflective member 50 and aligned with the apertures 43 of the cover 40 and the blind holes 16 of the housing 10 respectively, and further includes one or more (such as three) sockets or seats 56, 57, 58 formed or provided therein and extended into the space 52 of the reflective member 50 for engaging with the frame 60, and includes a recess 59 formed or provided in the seats 56, 57, 58 and communicating with the cavities 55 of the reflective member 50 for engaging with the frame 60, and the frame 60 includes a body or head 61 having a triangular shape and engaged with the recess 59 of the seats 56, 57, 58 for anchoring or retaining or securing to the head 61 of the frame 60 to the reflective member 50, and includes one or more (such as two) legs or rods 62, 63 extended from the head 61 of the frame 60 and parallel to each other.

As shown in FIG. 2, the legs or rods 62, 63 of the frame 60 are extended or engaged into or through the cavities 55 of the reflective member 50, and then engaged into or through the apertures 43 of the cover 40, and then engaged into the blind holes 16 of the housing 10 respectively for supporting or separating or spacing the reflective member 50 from the circuit board 30 and/or the light element 31 for a suitable or selected space or distance, best shown in FIGS. 1-2 and 6, and arranged for allowing the lights generated by the light bulbs or light element 31 to be suitably reflected by the reflective surface 51 of the reflective member 50 (FIG. 6). The fasteners 21 may be engaged with one or both of the rods 62, 63 for solidly and stably anchoring or retaining or securing the frame 60 to the housing 10. Another cover or shield or cap 70 is attached or mounted or secured to the reflective member 50 with the latch or fastener 54, and includes a recess or space or depression 71 formed therein for receiving or engaging with a lid 72 which may cover and shield the latch or fastener 54.

In operation, as shown in FIGS. 2 and 6, the reflective member 50 may be attached or mounted or secured to the upper or free end portion of the housing 10 with the frame 60, and suitably spaced or separated from the circuit board 30 and/or the light element 31 with the frame 60, and includes the reflective surface 51 faced or directed toward the light element 31 for suitably reflecting the light generated by the light element 31. It is to be noted that the circuit board 30, and particularly the light element 31 is exposed and spaced or separated from the reflective member 50 such that the light generated by the light element 31 may be completely emitted out through the space between the reflective member 50 and the light element 31, and the heat generated by the light element 31 may also be completely dissipated through the space between the reflective member 50 and the light element 31.

Accordingly, the light assembly in accordance with the present invention includes a structure for allowing the light assembly to be easily and quickly assembled, and includes a reflective structure for suitably reflecting the light generated by the light assembly and for allowing the heat generated by the light element to be suitably dissipated through the space between the reflective member and the light element.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A light assembly comprising:
a housing including a platform, said housing including a chamber formed therein,
a light element disposed on said platform of said housing,
a circuit board disposed on said platform of said housing for supporting said light element,
two wires coupled to said circuit board and engaged in said chamber of said housing,
a cover attached to said housing and engaged onto said circuit board for anchoring said circuit board to said housing, said cover including an opening formed therein for receiving and engaging with said light element and for allowing said light element to be exposed, and for allowing the light generated by said light element to be emitted out of said cover,
a reflective member supported and spaced from said light element, and said reflective member including a reflective surface provided therein and faced toward said light element for reflecting a light generated by said light element, and
a frame engaged between said reflective member and said light element for separating said reflective member from said light element for a distance, and for allowing the light generated by said light element to be reflected by said reflective surface of said reflective member, and for allowing a heat generated by said light element to be dissipated.

2-3. (canceled)

4. The light assembly as claimed in claim 1, wherein said housing includes a peripheral flange extended laterally and outwardly therefrom, and a gasket is attached onto said housing and engaged with said peripheral flange of said housing.

5. The light assembly as claimed in claim 1, wherein said reflective surface of said reflective member is a cone-shaped reflective surface.

6. A light assembly comprising:
a housing including a platform, said housing including at least one blind hole formed therein,
a light element disposed on said platform of said housing,
a reflective member supported and spaced from said light element, and said reflective member including a reflective surface provided therein and faced toward said light element for reflecting a light generated by said light element, and
a frame engaged between said reflective member and said light element for separating said reflective member from said light element for a distance, and for allowing the light generated by said light element to be reflected by said reflective surface of said reflective member, and for allowing a heat generated by said light element to be dissipated, and said frame including a head engaged with said reflective member, and at least one rod extended from said head of said frame and engaged into said at least one blind hole of said housing.

7. The light assembly as claimed in claim 6, wherein said head of said frame includes a triangular shape.

8. The light assembly as claimed in claim 6, wherein said reflective member includes a recess formed therein for engaging with said head of said frame.

9. The light assembly as claimed in claim 8, wherein said reflective member includes at least one seat provided therein and having said recess formed in said seat.

10. The light assembly as claimed in claim 6, wherein said reflective member includes a cap secured to said reflective member for shielding and covering said head of said frame.

11. The light assembly as claimed in claim 10, wherein said cap includes a depression formed therein, and a lid received and engaged in said depression of said cap.
